(19) United States
(12) Patent Application Publication
(10) Pub. No.: US 2005/0036439 A1
(43) Pub. Date: Feb. 17, 2005

(54) Accommodating additional data on an optical data carrier disk

(76) Inventors: Bob Van Someren, Eindhoven (NL); Wilhelmus Robert Koppers, Eindhoven (NL)

Correspondence Address: US Philips Corporation;Intellectual Property Department, PO Box 3001, Briarcliff Manor, NY, 10510, US

(21) Appl. No.: 10/498,144

(22) PCT Filed: Dec. 2, 2002
(86) PCT No.: PCT/IB02/05098

(30) Foreign Application Priority Data
Dec. 12, 2001 (EP) 01204855.9

(51) Int. Cl. G11B 7/24; G11B 7/00

(52) U.S. Cl. 369/275.4; 369/47.27

(57) ABSTRACT

An optical data carrier disk reader is adapted for detecting a slope of a wall in a data track of an optical disk. An optical disk has pits (811, 812), having walls with at least two different steepnesses, in its data track. The steepness represents information written on the optical disk. A method for making an optical disk stamper (8) comprising exposing portions of a photo-sensitive layer to electro-magnetic radiation is also described. By controlling the variation of the focal point during exposure, the inclination of the walls between the bump (811, 812) or pit forming portions and the “land” forming portions of the surface of the optical disk stamper (8) can be controlled.

The invention relates to an optical disk reader device, to a method for making an optical disk stamper, to an optical disk, to a controller device, to a computer program, and to a data storage device.

In general, optical disk reader devices read data from optical disks such as a compact disk (CD) or a digital versatile disk (DVD).

It is an object of the invention to store more data on an optical digital data carrier disk and to be able to read more data from such disks.

For storing more data, according to one aspect of the present invention, an optical disk according to claim 1 is provided. For reading such a disk, an optical disk reader according to claim 5, a method according to claim 7 and a computer program according to claim 11 are provided. For manufacturing a stamper from which such a disk can be manufactured, the invention provides a method according to claim 8.

Specific embodiments of the invention are set forth in the dependent claims.

Further details, aspects and embodiments of the invention will be described with reference to the attached drawings.

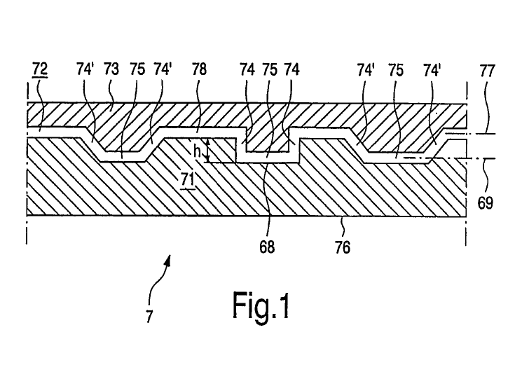

FIG. 1 schematically shows a cross-section along a data track of an example of an optical disk according to the invention.

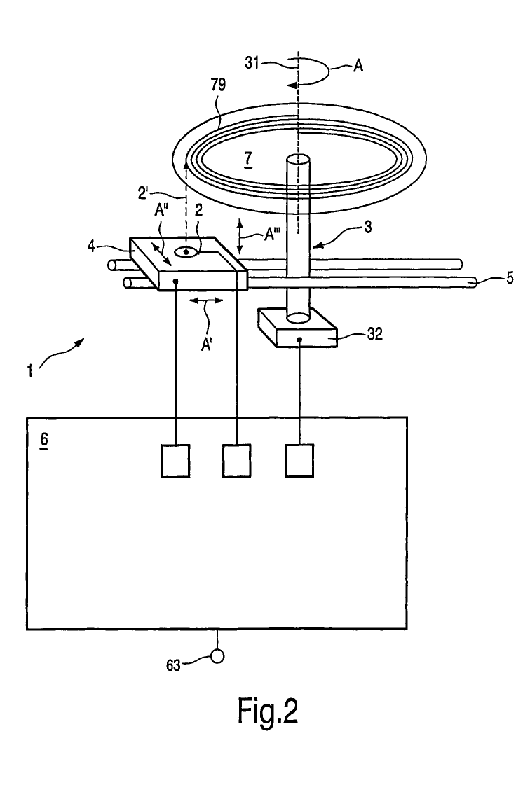

FIG. 2 schematically shows an example of an optical disk reader apparatus according to the invention

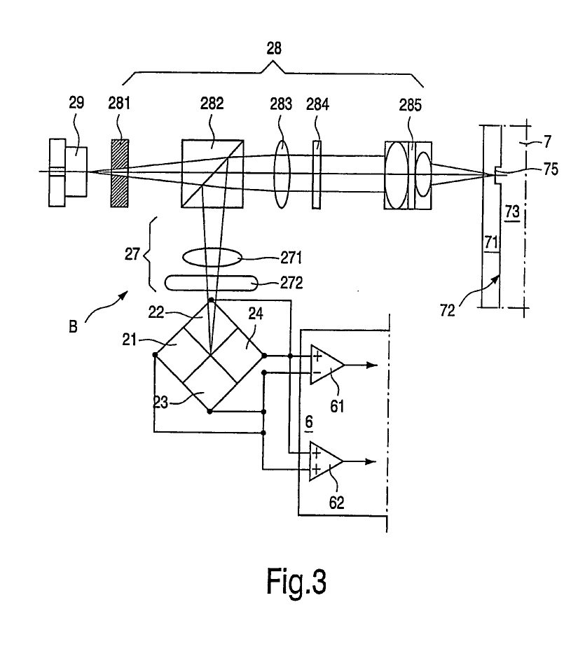

FIG. 3 schematically shows a reader device for in the optical disk reader of FIG. 2.

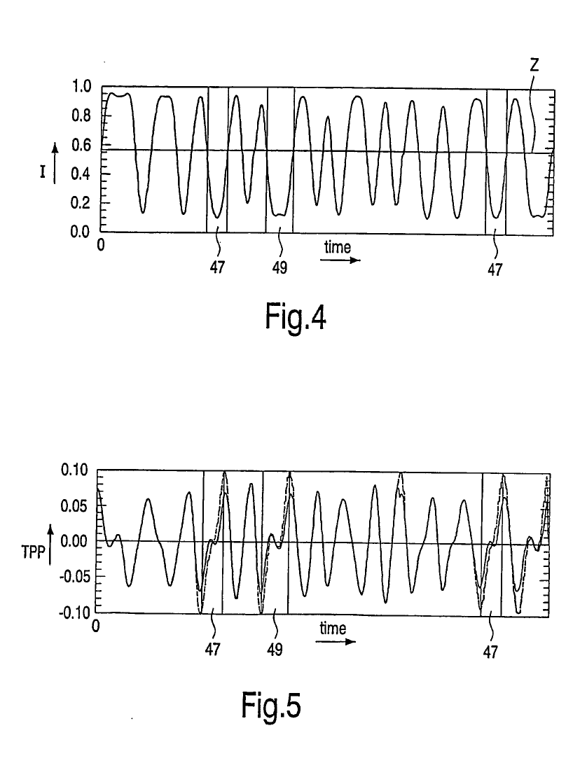

FIG. 4 shows a graph of the simulated reflection of laser radiation on an optical disk according to the invention as a function of time

FIG. 5 shows a graph of the tangential push-pull signal on an optical disk according to the invention as a function derived from the reflection of FIG. 4.

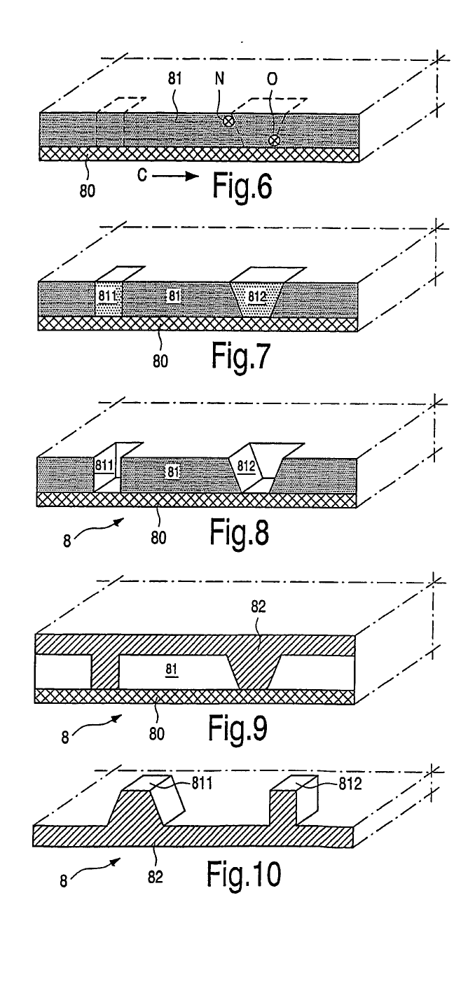

FIGS. 6-10 show exploded, perspective views of several stages of an example of a method for making an optical disk stamper according to the invention.

The example of an optical disk 7 according to the invention shown in FIG. 1 comprises a base layer 71, a reflective layer 72 with a reflective boundary 68 and a protection layer 73. Seen from a reading side 76 of the disk, the reflective layer 72 has bumps 75. Of course, seen from the other side, the bumps are pits. The bumps project from a base level 77 to a bump level 69. The area of the reflective layer at this level is the “pit” 78. The bumps 75 represent data written on the optical disk and constitute a spiral data track, which is denoted with 79 in FIG. 2.

In use, the optical disk 7 may be read from the reading side 76 by projecting a laser radiation beam onto the disk and detecting the amount of reflected radiation at a sensor. In the shown example, the height h over which the bumps 75 project from the land 78 is around or at a quarter of the wavelength of the projected radiation. When the disk rotates, the radiation reflected to the sensor from the lands has traveled ¼+¼=½ of a wavelength further than radiation reflected from the bumps 75. The radiation reflected from the land is therefore shifted by ½ a wavelength relative to light (visible or invisible) reflected from the bumps and is thus out of phase with the radiation reflected from the bumps. Thus, if a bump 75 is present in the light beam, the light reflected from the bump cancels out light reflected from the land, so that no or substantially less radiation is reflected to the sensor. If the beam hits land only, no interference occurs.

In the present context the planes of the base level 77 and the bump level are denoted as horizontal planes and the orientation perpendicular thereto is denoted as vertical.

The bumps 75 have walls 74, 74′ with different slopes (in this context, a vertical wall is also regarded as having a slope). For example, some of the walls 74 are substantially vertical, while other ones of the walls 74′ are less steep. Thus, there are several types of walls on the disk which can be distinguished from each other by the steepness of the walls. This distinction can be used to store data on the disk. Thereby an extra data channel is provided. The data channel may for example be used to increase the data density of the disk or for copyright protection. The extra data channel is independent of the information represented by the bumps and does not influence the behavior of the disk in conventional optical disk readers which are not capable of distinguishing walls of different steepness from each other. Thus, the extra data channel is fully backward compatible.

Furthermore, the extra information stored in the slopes or steepnesses of the walls sloping in the direction of the data track cannot easily be copied from the optical disk onto another optical disk disk for two reasons. Firstly, the known optical data readers do not output the information on the extra channel, so obtaining the data in the extra data-channel would require a modification to the optical disk reader hardware. Secondly, writable optical disks, such as rewritable CD's, do not have a bump structure, so it is not possible to store information onto the walls of the bumps in such types of disks.

FIG. 2 schematically shows an example of an optical disk reader 1 according to the invention. The shown reader 1 can for example be a compact disk (CD) reader or a digital versatile disk (DVD) reader. The reader 1 comprises a reader unit 2 for directing a light beam 2′ to the disk 7 and for sensing light reflected from the disk 7 and a data carrier holder 3. The reader unit 2 and the data carrier holder 3 are movable with respect to each other in a conventional manner as indicated by arrows A′,A″,A′″. The data carrier holder 3 holds the optical disk 7 in position with respect to the reader unit 2.

The data carrier holder 3 and the disk 7 carried thereby can be rotated by a motor 32 about an imaginary axis 31, as indicated in FIG. 2 by arrow A. The reader unit 2 is mounted on a sledge 4 and movable with respect thereto in the direction indicated by arrow A″. The sledge 4 is movable in the directions indicated by arrow A′ (perpendicular to directions indicated by arrows A″ and A′″) by sliding the sledge 4 over gliders 5. The movement of the reader unit 2 and the sledge 4 is driven by one or more suitable actuators, for instance electro motors, which are not shown in the drawing and well known in the art. The distance between the reader unit 2 and the optical disk 7 is also adjustable, because the reader unit 2 is also movable with respect to the optical disk 7 in the direction indicated with arrow A′″

The reader unit 2, the sledge 4, the motor 32 and the actuators are connected to a control circuit 6, which may be connected to other devices and/or circuits inside or outside the data reader device via a control terminal 63. The control circuit 6 may perform various functions. One of these functions is processing signals from or to the reader unit 2. Other functions may for example be control of the rotational speed of the motor 32 and optical disk 7, control of an actuator which moves the sledge or the reader unit 2. In FIG. 2, the control circuit 6 is depicted as a single unit, however, the device may physically be distributed over separate units.

Data may be read from bit positions on the data track 79 using the reader unit 2. By rotating the holder 3 the optical disk 7 is rotated with respect to the reader unit 2. The reader device 2 can be moved in a radial direction with respect to the imaginary axis 31 by moving the reader unit 2 with respect to the sledge 4 and/or moving the sledge 4 along the gliders 5. Thus, data may be read by the reader unit 2 from the track 79 of the optical disk 7.

In the shown example, the reader unit 2 directs a laser beam indicated in FIG. 2 by dotted line 2′ to the disk 7. The laser beam 2′ is generated by a laser source and focused on the optical disk 7 by an objective lens. The laser source and the lens are part of the reader unit 2 and are not shown in FIG. 2. The laser beam 2′ is reflected by the optical disk 7 and detected by the reader unit 2.

The reader unit 2 is provided with means for determining the slope of walls on the optical disk 7. The determined slope may then be converted into a data signal. For example if the slope is determined to be below a certain threshold value, if may be regarded as a binary zero and if the inclination of the wall is above the threshold it may be regarded as a binary one.

The reader device 2 may be implemented as is shown in FIG. 3. In FIG. 3, a laser source 29, for example a laser diode, is located in line with an optical system 28, which, in use, projects laser radiation from the laser source onto an optical disk 7 and directs reflected radiation to a set of detectors 21-24.

The detectors 21-24 output the read data as well as one or more signals indicative of the position of the reader unit 2 with respect to the data track 79 of the optical disk 7. The signal can also form a feedback signal in response to a signal sent by the reader unit 2 to the data carrier device 3.

The optical system 28 comprises a diffraction grating 281, which projects radiation through a beam splitter 282 and a collimator lens 283 onto a quarter wave length plate 284. The plate 284 transmits the radiation onto an objective lens 285 which focuses the radiation onto an optical disk 7.

In use, the grating 281 converts the radiation into a central peak plus side peaks. These three beams pass through the polarizing beam splitter 282. The splitter transmits polarizations parallel to the plane of the drawing. The emerging radiation, now polarized parallel to the plane of the drawing, is then collimated by the collimator lens 283.

The collimated radiation goes through the ¼ wave plate 284. The plate 284 converts the collimated radiation into circularly polarized radiation. The circularly polarized radiation is then focused down onto the disk 7 by the objective lens 285. If the radiation strikes “land” it is reflected back into the objective lens. If part of the radiation strikes a bump, that part cancels out reflection from the “land” because of the interference, as is described above with reference to FIG. 1.

After reflection, the radiation passes through the ¼ wave plate again 284. Since it is going the reverse direction, it is polarized perpendicular to the original beam (i.e. perpendicular to the plane of the drawing). When the polarized return radiation hits the polarizing beam splitter 282, it is reflected to the lens system 27 and not transmitted through the beam splitter 282, the radiation then reflects through a focusing lens 271 and a cylindrical lens 272 of the lens system 27 and is imaged on the detector arrangement 21-24.

The presence of bumps on the optical disk 7 is detected by the detectors in the detector array simply by the presence or absence of reflected radiation at any of the detectors. The inclination of the walls may be detected using differences between the detectors. For example, the tilt of the walls influences the tangential push-pull (TPP) signal, which is the signal representing differences in quantity of radiation between leading and trailing halves (leading and trailing being determined in the direction of progress of the disk with respect to the point of incidence of the radiation beam) of the reflected radiation incident on detectors 21-24. Thus the TPP signal is a measure for the tangential speed of the effects on the optical disk, i.e. the speed of the datatrack 79.

When a radiation beam passes across a bump 75, initially only the leading half of the light beam is positioned on the bump 75 and finally only the trailing part of the beam in directed to the bump 75. Therefore, intensity distribution of the reflected radiation varies with the progress of the beam across a bump. Therefore, a pulse-shaped signal forming the tangential push-pull signal is obtained, which represents the difference at a moment when the radiation beam reaches a bump or leaves a bump, that is, at an edge of the bump, if the wall is vertical. If the inclination of the wall is less steep, the TPP signal will be shaped differently. Difference shown in FIG. 5

Thus, the TPP is a measure of the inclination of the walls of the bumps on the optical disk In FIG. 3, the detectors 21-24 are connected to first and second operational amplifiers or opamps 61,62. The detectors, which may for example be photo-diodes, are connected to each other by pairs. Each pair 21,23;22,24 is formed by the detectors which are located side-by-side with respect to arrow B, which correspond to the direction of movement of the bumps with respect to the reader unit 2. The first opamp 61 outputs the TPP signal, while the second opamp 62 outputs the data signal related to the presence of the bumps as such. The first opamp 61 compares the signal at the input+with the signal at the input−and outputs a signal relating to the difference between the signals, thus determining the difference in intensity of laser radiation impinging on the pairs of detectors.

Detection of information can be carried out by monitoring the high frequency content of the TPP signal at the zero crossings of the normal HF signal, i.e. the reflected laser radiation. Since the TPP signal is already made available in virtually all optical disk readers, existing optical disk reader electronics designs require little adaptation to enable the readout of the extra information contained in the differences of steepness of the walls of the bumps.

In the graphs of FIGS. 4-5, the results of a simulation which shows the total signal and the TPP signals is depicted. In the simulation, two runs were made, one where all walls have the same slope and one where the bumps causing signal portions 47 and 49 were simulated to have an angle of 50 degrees, and where all other bumps still have walls having a slope of 55 degrees.

In the graph of FIG. 4, both total reflected radiation signals are plotted that resulted from both runs. As is seen, there is virtually no difference in the signals between the two runs.

In FIG. 5. the corresponding TPP signals are shown. The solid line represents the run where the walls have an angle of 55 degrees for all of the bumps, the dash-dotted line is the case where the slope of the walls for the bumps causing the pulses indicated with 47 and 49 was changed from 55 to 50 degrees. At the zero crossings of the signal, i.e. the moments the reflected signal crosses line Z, the difference between the TPP signals of both runs is most evident. The simulations shows that the change of the slope angles of the pits does not change the quality of the reflected radiation signal and there is only a small increase in jitter.

In FIGS.6-8 a stamper 8 for manufacturing optical data carrier disks according to the invention is shown in successive stages of a method for making the stamper. FIG. 6 shows a glass plate 80 with a photo-sensitive layer 81 which is exposed to laser radiation. At places where pits (for forming bumps in the disk) have to be created, the laser radiation is projected. Where land has to be created, the laser radiation is not projected onto the photosensitive layer. By changing the focal point of the radiation, the depth profile of the laser radiation is adjusted. As the laser moves along the surface in the direction indicated with arrow C, the focal point is changed. The depth in the photosensitive layer of the focal point determines the inclination of the wall of the pit which is formed, as is illustrated by in FIG. 6 at points N and O.

As shown in FIG. 7, after exposure, the photo-sensitive layer has exposed portions 811, 812 with leading and trailing boundaries having different slopes. After exposure, the photo-sensitive layer 81 is developed. Thereby, the photo-sensitive layer is removed at exposed parts, resulting in gaps in the layer 81, as is shown in FIG. 8. Next, the developed layer 81 is covered with a stamper layer 82. In most stamper manufacturing processes the stamper layer 82 is a metal layer. Next, the glass plate 80 and the layer 81 are separated from the stamper layer 82 and the stamper is obtained using the stamper layer 82. As is shown in FIG. 10, the stamper 82 has bumps 811, 812 having walls with different slopes.

The invention is not limited to implementation in the disclosed examples of devices, but can likewise be applied in other devices. In particular, the invention is not limited to physical devices but can also be applied in logical devices of a more abstract kind or in a computer program which enables a computer to perform functions of an optical disk reader according to the invention or a method according to the invention when run on the computer. Furthermore, the leading and trailing walls need not be straight from the base level to the bump or pit level, but can for instance be stepped, concave or convex. Instead of by the steepness of the walls, the distinction between the walls of different categories can be made by distinguishing walls of different shape.

1. An optical data carrier disk (7) having an optically reflective boundary (68) determining a base level (77) and including a data track (79) readable by an optical disk reader, said data track (79) including a succession of at least pits or bumps (75) in said boundary (68), said pits or bumps each having a boundary portion on a pit or, respectively, bump level (69) different from said base level and boundary portions forming leading and trailing walls (74, 74′) interconnecting said pit or, respectively, bump level boundary portions with boundary portions on said base level (77) and forming leading and, respectively, trailing ends of pits or, respectively, bumps (75), said walls each having a steepness and each belonging to one of at least two wall categories, walls (74) of a first one of said wall categories having a first slope and walls (74′) of a second one of said wall categories having a second slope different from said first slope.

2. An optical disk (7) as claimed in claim 1, wherein said first slope differs from said second slope by the average steepness from the base level (77) to the pit level or the bump level (69).

3. An optical disk (7) as claimed in claim 2, wherein said first slope and said second slope have substantially the same shape.

4. An optical disk (7) as claimed in claim 1, wherein said walls (74, 74′) of said first and second categories each have a substantially constant steepness from the base level (77) to the pit level or the bump level (69).

5. An optical disk reader (1) for reading data from an optical data carrier disk (7), said disk reader having a disk holder (3) and a reading assembly (2) including means for directing a light beam onto successive portions of a data track (79) in a reflective boundary (68) of said disk (7) passed by said reading assembly (2), a sensor for sensing variations in light reflected from said boundary (68) caused by a succession of at least pits or bumps (75) in said data track (79) and means for generating a signal from said light variations and outputting said signal, said signal corresponding to said succession of at least pits or bumps (75) in said data track (79), further including means for detecting and distinguishing variations in reflected light caused by leading and trailing walls (74, 74′) of said pits or bumps of a first wall category having a first slope from variations in said reflected light caused by leading and trailing walls (74′) of said pits or bumps of a second wall category having a second slope different from said first slope, said means for generating a signal from said light variations being adapted for generating and outputting said signal or a further signal in accordance to detected and distinguished walls (74, 74′) of said first and second wall categories in said data track (79).

6. An optical disk reader (1) as claimed in claim 5, wherein said reading assembly (2) comprises:
at least two photo-electrical sensors (21, 23 and 22, 24), each for generating a signal in response to electro-magnetic radiation impinging thereon,
the first one of said photo-electrical sensors being positioned to receive light reflected from a portion of said light beam leading in the direction of progress along said data track (79) and the second one of said photo-electrical sensors being positioned to receive light reflected from a portion of said light beam trailing in the direction of progress along said data track (79), and
subtractor means (61) connected to the first and second photo-electrical sensors (21, 23 and 22, 24) for generating a signal representing the difference in intensity between light detected by said first photo-electrical sensor (21, 23 or 22, 24) and light detected by said second photo-electrical sensor (22, 24 or 21, 23).

7. A method for reading data from an optical data carrier disk (7), comprising:
passing a successive portions of a data track (79) including a succession of at least pits or bumps (75) in an optically reflective boundary (68) of an optical data carrier disk (7) through a light beam (2′),
sensing intensities of light reflected from said boundary (68) including said succession of at least pits or bumps (75) in said data track (79), and
generating a signal from said light variations and outputting said signal, said signal corresponding to said succession of at least pits or bumps (75) in said data track (79), wherein intensities of reflected light caused by leading and trailing walls (74, 74′) of said pits or bumps are detected, and
wherein a portion of said intensities caused by leading and trailing walls (74, 74′) of a first wall category having a first slope are distinguished from another portion of said intensities caused by leading and trailing walls (74′) of a second wall category having a second slope different from said first slope, and
wherein said signal or a further signal is generated and outputted in accordance to detected and distinguished walls (74, 74′) of said first and second wall categories in said data track (79).

8. A method for manufacturing a stamper for manufacturing optical data carrier disks, comprising
exposing successive portions (811, 812) of a data track trajectory in a photo-sensitive layer (81) to one of a beam of electromagnetic radiation and a beam of particles, said beam having a focal point (N, O) located in said photo-sensitive layer (81);
varying the depth of said focal point (N, O) with progress along said data track trajectory;
developing said photo-sensitive layer (81);
covering said developed photo-sensitive layer (81) with a stamper layer (82) and
separating said developed photo-sensitive layer (81) from said stamper layer (82).

9. A method as claimed in claim 8, wherein said beam is selectively switched on and off with and without varying the depth of said focal point (N, O) with progress along said data track trajectory, such that walls of exposed portions (811; 812) of said photo-sensitive layer (81) with different slopes are obtained.

10. A method as claimed in claim 8, wherein the rate of variation of the depth of the focal point per unit of progress along said data track trajectory is selectively varied, such that walls of exposed portions (811; 812) of said photo-sensitive layer (81) with different slopes are obtained.

11. A computer program for controlling a data processor for interpreting a signal from a reading assembly corresponding to variations in light intensity of light reflected from an optical data carrier disk, comprising:
instructions for reading a signal representing the intensity of light reflected from said boundary (68) including said succession of at least pits or bumps (75) in said data track (79),
instructions for generating a signal from said light intensities and for outputting said signal, said signal corresponding to said succession of at least pits or bumps (75) in said data track (79),
instructions for reading detected intensities in reflected light caused by leading and trailing walls (74, 74′) of said pits or bumps,
instructions for distinguishing detected intensities caused by leading and trailing walls (74, 74′) of a first wall category having a first slope from detected intensities caused by leading and trailing walls (74′) of a second wall category having a second slope different from said first slope, and
instructions for generating and outputting the signal or a further signal in accordance to detected and distinguished walls (74, 74′) of said first and second wall categories in said data track (79).

12. A digital data carrier including data representing a computer program as claimed in claim 11.
